(19) United States
(12) Patent Application Publication
(10) Pub. No.: US 2007/0257508 A1
(43) Pub. Date: Nov. 8, 2007

(54) INTERNAL CANOPY STRUTS

(76) Inventors: Landon N. Ball, North Augusta, SC (US); Anthony J. Sanville, Evans, GA (US); Donald S. Hanson, Augusta, GA (US)

Correspondence Address: HARNESS, DICKEY & PIERCE, P.L.C., P.O. BOX 828, BLOOMFIELD HILLS, MI, 48303, US

(21) Appl. No.: 11/381,893

(22) Filed: May 5, 2006

(51) Int. Cl. B62D 25/06

(52) U.S. Cl. 296/102

(57) ABSTRACT

A vehicle generally includes a frame. A first body panel is operably coupled to the frame. A strut extends generally into the first body panel and is operably coupled to the frame.

### FIELD

The present disclosure relates to golf cars and more specifically to struts for a golf car and utility vehicles.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many golf cars are equipped with a front windshield assembly that provides a transparent barrier to the passengers of the golf car. Many golf cars are also equipped with a roof canopy. In one arrangement, a front windshield assembly is attached between a pair of upwardly extending struts arranged on a front end of the golf car. The struts define a window frame and typically connect with the roof canopy of the golf car. In other arrangements, the struts can be free standing at an upper end. In yet other arrangements, the struts can support a front portion of the roof canopy and have no windshield attached thereto.

Some strut assemblies on golf cars attach between lower strut portions and the golf car at an external location. For example, strut members can be coupled to sides of a front body portion. Alternatively, strut members may be coupled to an upper surface of the front body portion. Often, these configurations result in the struts catching on brush when maneuvering around outdoors due to an increased lateral extent. These configurations also result in a design that is tough to wash, catches dirt, and has a less streamlined appearance.

### SUMMARY

According to the present disclosure, a vehicle is provided including a frame. A first body panel is operably coupled to the frame. A strut extends generally into the first body panel and is operably coupled to the frame.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present teachings in any way.

FIG. 1 is a perspective view of a golf car including the strut assembly of the present teachings; and

FIG. 2 is an exploded view of a front portion of the golf car of FIG. 1.

### DETAILED DESCRIPTION OF THE VARIOUS EMBODIMENTS

The following description of various embodiments is merely exemplary in nature and is in no way intended to limit the present teachings, application, or uses.

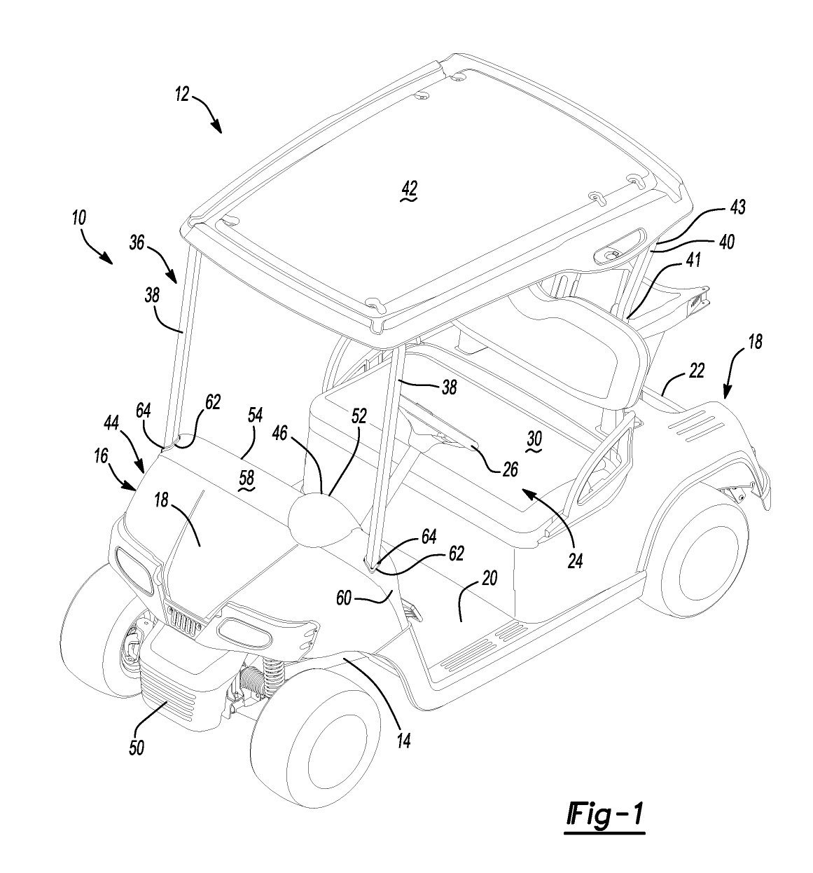

With initial reference to FIG. 1, a strut assembly constructed in accordance to the present disclosure is shown and identified generally at reference numeral 10. The strut assembly 10 is illustrated operably connected to an exemplary golf car 12. It is appreciated that the golf car 12 is merely exemplary and that the strut assembly 10 can be adapted for use with other golf car configurations. Furthermore, the strut assembly 10 described herein is not limited for use with golf cars and can also be used with other vehicles such as, but not limited to, utility vehicles, lawnmowers, and other turf care vehicles.

With reference to FIG. 1, the golf car 12 can include a frame 14 having a front end 16 and a rear end 18 mounted thereon. The rear end 18 can include a golf bag storage area 22 and a passenger seating area 24. The passenger seating area 24 can include a steering wheel 26, accelerator and brake pedals (not shown), a seat 30, and a floor portion 20.

The strut assembly 10 can include a pair of front struts 38 and a pair of rear struts 40 supporting a roof canopy 42. The pair of front struts 38 can extend between the front end 16 of the golf car 12 and the roof canopy 42 and the pair of rear struts 40 can extend between the rear end 18 of the golf car 12 and the roof canopy 42. The front struts 38 can optionally support a windshield 44 therein. Alternatively, the golf car 12 can have no roof canopy 42 and struts 38 can be freestanding at an upper end. The front struts 38 can also include a cross-member (not shown) connecting the upper ends. The rear struts 40 can be coupled to a seat back support 45 at a first end 41. A second end 43 can be coupled to and support a rear portion of roof canopy 42. The rear struts 40 can be two separate members. Alternatively, rear struts 40 can include a cross-member (not shown) connecting second ends 43.

The front portion 16 of golf car 12 can include a front body assembly 44 having an instrument panel 46, a front cowl 48, and a bumper 50. The instrument panel 46 can include a trim portion 52 mounted to the front surface 54 of the main body portion 56. The main body portion 56 can include an upper surface 58 and side surfaces 60. The upper surface 58 can include apertures 62 having a portion of front struts 38 passing therethrough. The apertures 62 can have an outer profile similar to the cross-section of the portion of the struts 38 passing therethrough. The front struts 38 can have a seal member 64 disposed around a circumferential portion thereof proximate the apertures 62. The seal member 64 can be any appropriate structure for providing a seal between the apertures 62 and the struts 38, such as a molded rubber member.

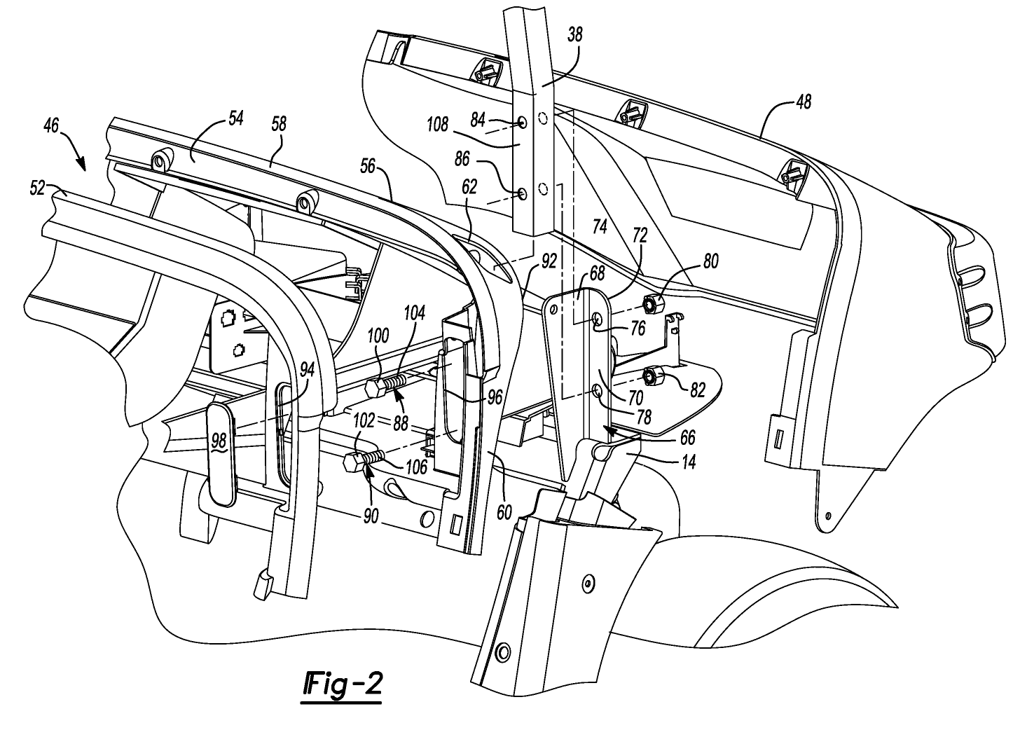

As shown in FIG. 2, the frame 14 can include a flange 66 extending behind front surface 54 of the instrument panel 46. The flange 66 can have a side member 68 and a front member 70 forming an L-shaped body. The flange 66 can generally house a portion of the front strut 38. The portion of the front strut 38 housed by the flange 66 can have a rectangular body that is abutted on two sides by side member 68 and front member 70. The front member 70 can include front and rear surfaces 72, 74. A series of apertures 76, 78 can be formed through the front member 70. A series of nuts 80, 82 can be coupled to the front surface 72 of the front member 70. A lower portion of the front struts 38 can also include a series of apertures 84, 86 therein.

Bolts 88, 90 can extend into apertures 84, 86 in the front struts 38 and apertures 76, 78 in the flange 66. Bolts 88, 90 can include threaded shanks 104, 106 for engaging nuts 80, 82 and thereby coupling the frame 14 to the struts 38. The bolts 88, 90 can include driving portions, such as bolt heads 100, 102. When coupled to the struts 38, flange 66 and nuts 80, 82, the bolt heads 100, 102 can abut the rear surface 108 of the strut 38. While the description incorporates the use of bolts for attachment, it should be understood any number of fasteners or fastening methods can be appropriate. For example, rivots or welding can be employed as well. Also, nuts 80, 82 can alternatively be free to rotate relative to the front surface 72 rather than being coupled thereto.

The instrument panel 46 can be generally open at a rear portion 92, generally providing access to the frame 14 and struts 38 during assembly. When assembled, the front cowl 48 generally abuts rear portion 92 of the main body portion 56 of the instrument panel 46 and provides a cover for the front portion 16 of the golf car 12, concealing the connection between the struts 38 and the flange 66.

The instrument panel 46 can include openings 94, 96 extending through the trim portion 52 and the main body portion 56 to provide access to the flange 66 and strut 38 coupling. The openings 94, 96 can also provide access to bolt heads 100, 102. A cover 98 can be provided to conceal the openings 94, 96. The cover 98 can be secured to the instrument panel 46 through a snap fit engagement or any other suitable attachment means. While the present teachings show cover 98 attached to the trim portion 52, the cover 98 can alternatively be attached to the main body portion 56.

The attachment of the struts 38 between the side surfaces 60 can allow the use of larger struts. Specifically, the struts 38 can be made from square tubing having a cross-section with dimensions of approximately 1.25 inches by 1.25 inches. Alternate dimensions can be used as required for specific applications. The struts can be comprised of a variety of different materials such as steel or aluminum and can include a number of different finishes such as natural, painted, chrome and a black powder coat finish.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A vehicle comprising:
a frame;
a first body panel operably coupled to said frame; and
a strut extending generally into said first body panel and operably coupled to said frame.

2. The vehicle of claim 1, wherein said first body panel includes an upper surface generally extending between a first side and a second side of said vehicle, said strut extending into said first panel through said upper surface generally between said sides.

3. The vehicle of claim 1, wherein said frame includes a flange extending therefrom, said flange coupled to said strut.

4. The vehicle of claim 3, wherein said flange includes at least one mounting aperture, said strut including at least one mounting aperture generally aligned with said mounting aperture in said frame and a fastener passing through said apertures, thereby coupling said flange to said strut.

5. The vehicle of claim 4, further comprising a nut threadingly engaged with a threaded portion of said fastener.

6. The vehicle of claim 5, wherein said nut is fixed to said flange proximate said mounting aperture in said flange.

7. The vehicle of claim 4, wherein said first body panel includes an opening providing access to said strut at a location on said strut proximate said fastener.

8. The vehicle of claim 7, wherein said opening is disposed through a portion of said first body panel within a passenger compartment of said vehicle.

9. The vehicle of claim 8, wherein said fastener includes a driving portion, said driving portion being accessible from said opening.

10. The vehicle of claim 7, further comprising a cover coupled to said first body panel, said cover configured to conceal said opening in said first body panel.

11. The vehicle of claim 3, wherein at least a portion of said strut has a generally rectangular body and at least a portion of said flange has a first member and a second member generally extending from said first member, said second member generally abutting a first side of said rectangular body and said first member generally abutting a second side of said rectangular body.

12. The vehicle of claim 1, wherein said first body panel includes an aperture having a portion of said strut passing therethrough, said aperture generally conforming to a cross-section of said portion of said strut.

13. The vehicle of claim 12, further comprising a sealing member disposed around a perimeter of said aperture and a circumference of said strut proximate said aperture.

14. The vehicle of claim 1, further comprising a second body panel disposed adjacent said first body panel and proximate a front of said vehicle, said second body panel configured to conceal said coupling between said strut and said frame.

15. The vehicle of claim 14, wherein said second body panel comprises a cowl panel.

16. The vehicle of claim 1, wherein said first body panel is located at a front portion of said vehicle.

17. The vehicle of claim 16, wherein said first body panel comprises an instrumentation panel.

18. The vehicle of claim 1, further comprising a canopy, said canopy coupled to an upper portion of said strut.

19. The vehicle of claim 1, wherein said vehicle is a golf car.

20. A vehicle comprising:
a frame;
a first body panel operably coupled to said frame; and
a strut extending generally into said first body panel and operably coupled to said frame, said first panel including an aperture having a portion of said strut passing therethrough.

21. The vehicle of claim 20, wherein said aperture generally conforms to a cross-section of said portion of said strut.

22. The vehicle of claim 20, wherein said vehicle is a golf car.

23. The vehicle of claim 20, wherein said first body panel is located at a front portion of said vehicle.

24. The vehicle of claim 23, wherein said first body panel comprises an instrumentation panel.

25. The vehicle of claim 20, wherein said first body panel includes an upper surface generally extending between a first side and a second side of said vehicle, said strut extending into said first panel through said upper surface generally between said sides.

26. A method of coupling a strut assembly to a golf car, said method comprising:
coupling a first body panel to a frame;
inserting a first end of a strut into an aperture in the first body panel;
aligning the first end of the strut with an attachment location; and
coupling the first end of the strut to the attachment location.

27. The method of claim 26, wherein said aligning includes aligning a first aperture in the strut with a first aperture in the attachment location.

28. The method of claim 27, wherein said coupling of the first end includes securing a fastener through the aperture in the strut and the aperture in the attachment location.

29. The method of claim 28, wherein said securing includes a threaded portion of the fastener threadingly engaging a nut.
